(19) United States
(12) Patent Application Publication
(10) Pub. No.: US 2011/0245056 A1
(43) Pub. Date: Oct. 6, 2011

(54) RIGID WINDOW APPLICATOR AND METHOD

(75) Inventors: David E. Machamer, Wauconda, IL (US); Thomas S. Slager, Barrington, IL (US)

(73) Assignee: Tamarack Products, Inc., Wauconda, IL (US)

(21) Appl. No.: 12/751,014

(22) Filed: Mar. 31, 2010

(51) Int. Cl. B31B 1/82

(52) U.S. Cl. 493/84; 493/905; 493/222

(57) ABSTRACT

Apparatus and method for affixing rigid transparent windows to folding cartons draws rigid window web material from a roll and scores and notches the window material in a continuous manner. Notch waste is removed and collected for disposal by the combination of vacuum and an air jet applied at the point of severance. The transparent window material is then provided to an accumulator and then to a stop-and-go adhesive application and material cutting stage, where adhesive is applied to the material which is cut into individual rigid window patches, with the accumulator serving as a buffer between the high speed continuous scoring and notching stage and the stop-and-go adhesive application and cutting stage. Adhesive-bearing individual window patches are applied to moving folding cartons with registration between the notches and cut lines as well as between the cut window blanks and carton blanks provided by a control system.

### FIELD OF THE INVENTION

This invention relates generally to the application of a window film over a die cut opening in a folding carton, and is particularly directed to the formation of rigid windows from rolls of rigid window materials and the application of the thus formed rigid windows to folding cartons in a single, high speed operation.

### BACKGROUND OF THE INVENTION

Window film is often applied over a die cut opening in a folding carton to provide a way to view the contents inside the carton. The window may be within the perimeter of one or more panels of the carton.

Windows in more than one panel of a carton are often referred to as panoramic windows, particularly if the window continuously extends from one panel, across the score or crease line at a corner of the carton, and into an adjacent panel.

In larger cartons, or in cartons containing more expensive or attractive contents, a substantially thicker window, approximately 0.007″ or thicker is used, as opposed to thinner films of approx 0.0005″ to 0.003″ thick. Such thicker window materials are known as rigid windows because their thickness renders them relatively stiff or rigid. Rigid windows may be made of such polymers as polyester, calendared PVC, or polystyrene sold by Plastic Suppliers, Inc. of Columbus, Ohio, and others.

When a rigid window is used in conjunction with a panoramic window opening in a folding carton, the rigid window material will typically require a score essentially aligning with the score, or corner, of the carton. Further, the rigid window will typically require die cut reliefs, or notches, where the rigid window material would otherwise overlie the carton material's score or crease. The relieved areas of the rigid window permit the carton to more easily fold along the carton's score line. If the window material were not so relieved, the score in the carton and the score in the overlying window material would resist folding not unlike the binding that would occur if a door were hinged along two offset hinge axes. The scoring and relieving requirements have historically been provided by pre-die cutting the rigid window blanks with either rotary or platen die cutting equipment which cut the window blank from a roll or from a larger sheet, respectively. This defines the complete perimeter and scores of the window blank. The pre-cut window blanks are collected in a stack for subsequent application to folding cartons.

Rigid windows, as well as thinner window films, have been applied to folding carton blanks by windowing machines such as those manufactured by Heiber+Schröder Maschinenbau GmbH of Erkrath, Germany. The operation of supplying an adhesive pattern to bond the window material and affixing the window in the desired position, or registration, on the carton is often referred to as window patching. In the case of the traditional Heiber+Schröder Maschinenbau GmbH machine, the rigid windows are supplied to the machine as precut and pre-scored singulated blanks. An adhesive pattern is applied to the folding carton blank and the rigid window is fed onto a vacuum cylinder which carries the rigid window on the cylinder's circumference until the rigid window is transferred to the carton blank over the adhesive pattern on the carton blank and in the desired location on the carton blank. More recently, Heiber+Schröder Maschinenbau GmbH has offered an attachment for feeding rigid window material from a roll, hot creasing, and die cutting the window material and applying it to folding cartons. The die cutting is a punching operation, performed while the window material is stationary, using male and female dies. This has practical limitations on speed as it uses a reciprocating punching station with male and female dies. Male and female dies are more complex and costly than a rotary die cylinder and rotary die cylinders are easy to set up and operate. The carton blank, now equipped with a window, is conveyed to a stacker where the flat carton blanks are collected for subsequent processing on a separate machine, i.e., a carton folder/gluer. On occasion a Heiber+Schröder Maschinenbau GmbH windowing machine has been built into a carton folder/gluer so that windows may be applied to folding cartons and the cartons folded and glued into a ready-to-fill configuration in a single pass operation.

Since about 2000, Tamarack Products of Wauconda, Ill., USA has made the Vista® window applicator (with reference to U.S. Pat. No. 6,772,663) which is typically installed on a carton folder gluer to apply windows in conjunction with the carton folding and gluing process for a single-pass operation. The Tamarack window applicator may also be installed on an abbreviated conveyor to separate the windowing process from the folding gluing process. The Vista® window applicator senses the lead edge of a carton as it is transported on carrier belts and a triggering signal activates feeding, gluing, and cutting axes to provide a cut window patch with a pattern of adhesive and delivers it for application onto a carton blank in the desired position. The Vista® window applicator differs from most other window applicators in several aspects. For example, the adhesive pattern is applied to the window film rather than the carton blank. This has the advantage that the adhesive pattern is inherently covered by the window patch. In systems where the adhesive pattern is applied to the carton blank, when a window misfeeds, i.e., is not placed in the proper location on the carton, or is missing altogether, the adhesive transfers onto various conveying components, e.g., transport belts, rollers and folding swords, fouling them with adhesive that can cause misfeeding of the carton blanks and the need to clean conveying belts and rollers to restore proper function. In approximately 2003, a die cut unit was added to the Vista® applicator to provide die cuts, for example perforations, for ease in the formation of an opening for the removal of facial tissues through a polyethylene window in a folding carton. The die cut unit was servo driven and coordinated with the feeding, gluing and cutting axes of the Vista® applicator.

Until the instant invention, however, the Vista® window applicator has not been adapted to process rigid window materials.

### OBJECTS AND SUMMARY OF THE INVENTION

The instant invention relates to a new method and apparatus for providing rigid windows on cartons wherein the rigid window material is supplied to the apparatus as a roll of rigid window material, rather than as pre-die cut, pre-scored singulated blanks.

The instant invention also relates to a process that eliminates two off-line processing operations currently practiced in the prior art. Namely, the instant invention draws from a roll of rigid window material and die cuts, scores and singulates the blanks (previously a separate operation in the prior art); applies the singulated blanks onto folding cartons (normally a second separate operation in the prior art); and performs the folding and gluing operations (normally a third separate operation in the prior art), all in one pass, on a combined machine (instead of two or three separate machines as in the prior art). While the rigid window material is sometimes referred to as being “transparent” in the following description, the rigid window material may include printing or other graphic features and thus does not have to be entirely, or 100%, transparent as used with the present invention.

The instant invention enhances the operation of a combination of prior art machinery: a carton folder gluer and a Tamarack Vista® window applicator equipped with an optional die cut station. The present invention provides a new way of webbing the window material that utilizes a die cut station's anvil cylinder as a feeding cylinder. This new webbing approach also allows the die cut to operate at an essentially constant rate of rotation while accommodating the Vista® applicator's stop-and go operation.

A reconfigured die cylinder is used to cut notches and make fold scores (sometimes the scoring is done at an additional station in conjunction with die cutting).

A waste removal system follows the die cutting operation to remove the notch material

The inventive process further provides instant feedback as to the alignment of the window fold scores with the carton fold scores. In other words, if the window scores do not align with the carton scores, the carton folding process will be impeded, possibly interrupted. This immediate indication of misalignment then allows prompt corrections to be made, with minimal waste of window and carton materials. In comparison, the prior art processes are separated and so a large batch of windowed cartons may be faulty. While the alignment problem will be evident in the subsequent, separate carton folding/gluing process as an interruption or failure, the entire batch of faulty windowed cartons would likely have to be scrapped.

Further, the inventive apparatus and process provides some degree of self-alignment, or at least self-centering, of the window fold scores with the carton fold scores—this by virtue of the fact that the adhesive does not immediately dry and so the window may ‘nest’ or shift in the carton folding/gluing process to a position that allows the folding/gluing process to continue without a “jam” or “jam-up,” as such interruptions are often referred to in the art.

The following features of the present invention provide improved performance in the application of rigid windows to a folding carton in terms of increased reliability, higher speeds, monitor-free operation, roll film compatibility, improved waste ejection and removal, reduced material costs, immediate positioning accuracy feedback and simplified design.
In-line conversion of roll format rigid film which eliminates off line step of pre-die cutting, scoring, collecting and storing window blanks. Also eliminates the need to constantly monitor and refill the hopper of a ‘sheet’-fed window applicator.
Rotary die cutting of window film rather than flat bed die cutting. This allows continuous die cutting for better compatibility with roll format film and high speed production.
One embodiment's use of die cutter's anvil cylinder as a feed roll to assist in pulling the material off the roll and serving as a buffer between stop-and-go feeding and cutting of the Vista® applicator. This also eliminates the need for a separate, additional servo-driven pull-roil axis. U.S. Patent Application Publication No. US 2008/0202300 A1 dated Aug. 28, 2008 discloses various servo-driven feeding techniques.
Locating the die cut station upstream of the accumulator also allows die cutting to proceed at a relatively steady rotational speed, overcoming potential problems with slippage of film relative to rotary die cutting cylinder. The relatively steady speed eliminates die wear problems caused by relative motion (slippage) between the die and the window material that would otherwise occur during intervals or rapid acceleration or deceleration. Further, the relatively steady speed allows more time for waste ejection (of notches). Otherwise, in cases of rapid acceleration in stop-and-go motion of a die cylinder, the waste notch may pass through an ejection device in a very short time interval. A longer time interval is desirable because it allows an air blast and/or an applied vacuum more time to dislodge the waste notch from the window material web.
Potential of window material savings because the roll of window material can have a width equal to the net width of the window blank. Thus, the length of the window blank is crush cut by the Vista® applicator, with no perimeter of waste film as with many flatbed die cut processes. Thus, the only film waste is at the reliefs cut in conjunction with a fold score. This reduces and simplifies waste collection and disposal.
Waste notches are removed from the web by means of an applied vacuum. The vacuum chamber is novel in comparison to existing methods that rely on an air jet impinging on the window film, and/or a vacuum chute in some proximity to the other side of the web to collect dislodged waste notches. In the inventive apparatus, the web passes through a vacuum chamber, where the window film serves as at least one side of the chamber, i.e., the window film seals the vacuum chamber. This increases the effectiveness of the vacuum chamber and to an extent reduces the vacuum airflow required to remove and collect the waste notches—a potential for energy saving.
In cases where a panoramic window is folded as part of the folding/gluing process after application of the window patch, feedback as to the accuracy of the alignment between window score and carton score is immediate. In many cases, the freshly applied glue is still uncured so that, to an extent, the window score will self-align with the carton score.
The die cut operation is essentially continuous (without stopping) and the feeding, gluing and cutting in the Vista® applicator after the die cut are essentially stop-and-go. These two very different operating conditions are buffered by an accumulator. Registration of the feed, glue, and cut operations with the die cut is achieved by scanning a die cut feature in the window material after it is die cut. Scanning can be done with an optical scanner such as those provided by Keyence Corporation of America of Woodcliff Lake, N.J.
The die cut operations include cutting (to define portions of the perimeter of the rigid window patch, sometimes referred to as notching) and scoring (or providing lines of weakness to define a subsequent fold). Rather than combining cutting and scoring in one die cylinder, the cutting and scoring operations may be separated. In one embodiment, the scoring is accomplished by a scoring, or slitting, wheel in a continuous and unregistered manner. Thus, the rotary die cylinder is no longer continuously engaged with the rigid window material and the die cutting of notches could then be accomplished by a rotary die cylinder that could be rotated in a stop-and go, or cyclic, continuous manner. This would allow the timing of the die cutting operation to be adjusted to stay in register with printed or other markings (visible to the eye or sensed by other sensors such as infrared or radio frequency sensors). Separating the scoring and notching operations also offers economies in tooling. For example, the scoring can be done with relatively small and simple scoring wheels such as those provided by Rotometrics of Eureka, Mo. and the die cutting, while using a larger and more costly die cutting cylinder, also provided by Rotometrics, may be suitable for other die cutting jobs at different window repeats. For example, to provide a longer repeat than the nominal die cylinder circumference, the die cylinder, which is typically servo-driven, may be driven in a cyclic manner so that the portion of the die cylinder cutting the notches is rotated to match the speed of the window material. But between the notched portions, the die cylinder rotation may be slowed to allow more window material to pass by before the next notched portion engages the window material.

### BRIEF DESCRIPTION OF THE DRAWINGS

The appended claims set forth those novel features which characterize the invention. However, the invention itself, as well as further objects and advantages thereof, will best be understood by reference to the following detailed description of a preferred embodiment taken in conjunction with the accompanying drawings, where like reference characters identify like elements throughout the various figures, in which:

FIG. 1 is a schematic side view of a rigid window applicator in accordance with the principles of the present invention;

FIG. 2 is a plan view of a web incorporating cut lines, scores and notches as provided by the rigid window applicator of the present invention;

FIG. 3 is a plan view of a folding carton to which is applied a rigid window patch having adhesive applied thereto in accordance with the present invention;

FIG. 4 is a schematic side view of a scoring and cutting station which includes a splicing system for use with two rolls of rigid window material for use in one embodiment of the present invention; and

FIG. 5 is a schematic side view of a die cut station including a notch waste removal arrangement for use in the rigid window applicator of the present invention.

### DETAILED DESCRIPTION OF THE PREFERRED EMBODIMENTS

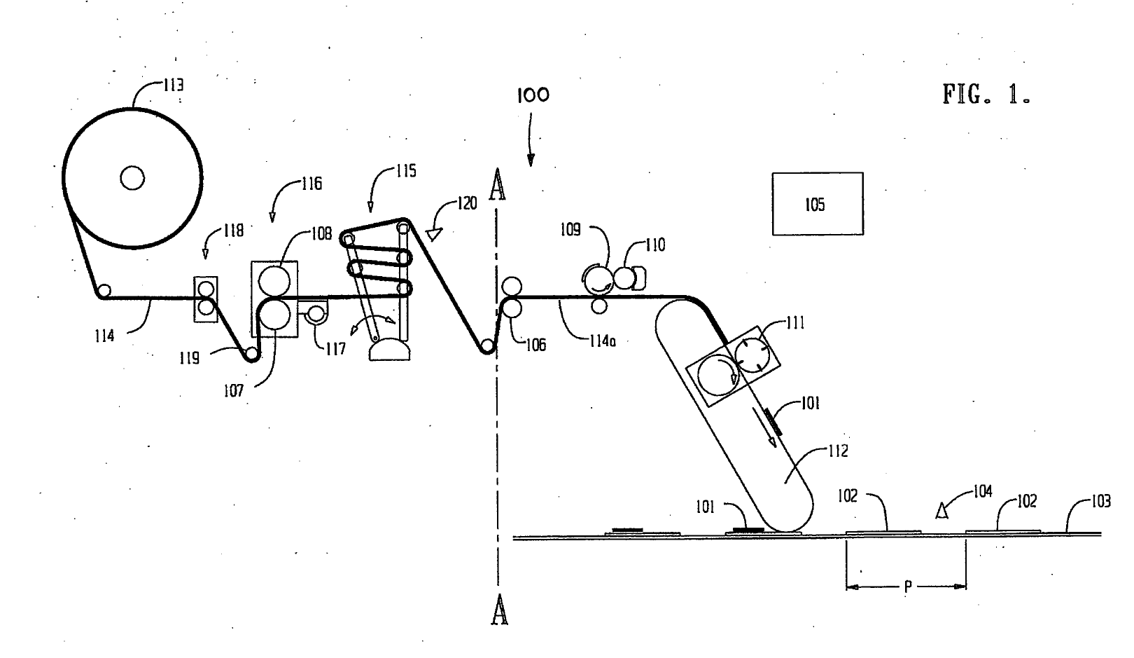

FIG. 1 is a schematic side view of a prior art Tamarack Vista® window applicator 100 installed on a carton folding/gluing machine which has been modified to provide rigid windows by adding a die cutting station in accordance with the present invention. Window applicator 100 is a device that supplies window patches 101 onto folding carton blanks 102. The carton blanks 102 are conveyed by transport, or carrier belt 103 of a carton folder gluer such as provided by Bobst of Lausanne, Switzerland. The lead edge or other feature on a folding carton blank 102 is sensed by a scanner 104 such as provided by Keyence of Osaka, Japan. The scanner signal is transmitted to a servo control system 105 which processes the signal and communicates with servo axes for the feeding roller 106, the die cut cylinders 107, 108, the gluing cylinders 109, 110, and the cutting cylinder 111. The control system 105, such as EcoDrive or IndraDrive supplied by Bosch Rexroth of Erbach, Germany and programmed using Visual Motion software, commands the various axes to rotate a specific amount and at varying speeds to provide a cut window patch 101 with a pattern of adhesive (not shown), said adhesive patterns serving to adhere the window patch 101 onto the carton blank 102. The window patch 101 is transported on a vacuum belt cartridge 112. The vacuum belt cartridge 112 is powered by a separate servo axis, also commanded by control unit 105. In normal operation the vacuum belt moves at a relatively constant speed, essentially matching the speed of transport belt 103. In some cases, slight amounts of speed mismatch may be desirable to reduce wrinkling of the window patch 101 as it is applied to the carton blank 102.

The window patch material is supplied from a roll 113. Window material unwinds from roll 113 to provide a web 114 of window material. For the rigid windows of the instant invention, a relatively thick and stiff window material such as 7 mil (0.007″, 180 micron) polyester such as supplied by Plastic Suppliers of Columbus, Ohio or 8 mil polyester from Klöckner-Pentaplast of America Inc. of Gordonsville, Va. is supplied in roll 113 and unwinds to provide web 114 to an accumulator 115.

Webs 114 and 114a shown in FIG. 1 are the same web, but they have different speed characteristics. Web 114 moves in a continuous manner at a generally fixed velocity. Web 114a typically moves in a stop-and-go manner, with high accelerations and decelerations. Since the carton blanks 102 are delivered at a variable pitch P, control unit 105 adjusts its commands to the servos driving the feed roller 106, gluing cylinders 109, 110 and cutting cylinders 111 so that in most modes of operation, each of these cylinders is driven in a stop-and-go manner. Accumulator 115 is provided to isolate or cushion the stop-and-go motion of web 114a downstream of the accumulator from the continuous rotation of roll 113. Accumulator 115 temporarily stores web 114 in a festooned shape, or configuration, in providing a transition motion between its continuous motion and its stop-and-go motion. Thus, web 114a upstream from accumulator 115 moves at a steadier rate and, in turn, this allows the relatively high-inertia roll 113 to rotate at a relatively constant rate and reduces the cyclic peaks of tension caused by the stop-and-go motion of web 114a.

A rotary die cutting station 116 including an anvil cylinder 107 and die cylinder 108 is driven by one servo motor (when the cylinders 107 and 108 are geared together) or by a servo motor driving each of the cylinders commanded by control unit 105. Die cutting station 116 is located upstream of the accumulator 115. This upstream position is advantageous for rotary die cutting because of the steadier speed of web 114. If the rotary die cut station 116 were located downstream of accumulator 115, the rapid accelerations and decelerations of both the web 114a and the die cutting cylinders 107 and 108 would have to perfectly match because the die cut cylinders engage the web for substantial portions, and in many cases 360° of rotation. Any inevitable speed mismatch could create slack in some portions of web 114a that would almost certainly cause lateral tracking problems, distort the web 114a, or cause deterioration (from scuffing, tearing or shearing) of the die cut pattern.

Web 114 may be wrapped around a significant portion of anvil cylinder 107 by routing the web via idler 119 or gripping the web 114 against the anvil cylinder 107 with a gripper roller or gripper wheels (not shown) as is known in the art. This allows the anvil cylinder 107 to also act as a feed roller and better assure that the speed of the web 114 more closely matches the speed of the die cutting cylinders 107 and 108.

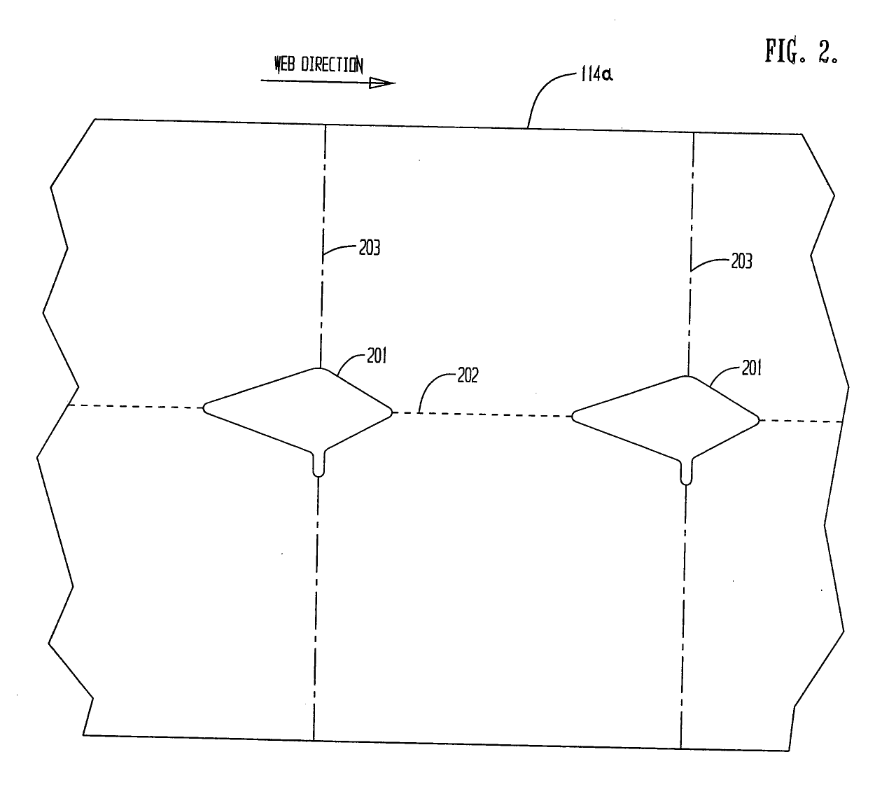

FIG. 2 is a plan view of a section of web 114a which includes a notch 201 and a score, or perforation, 202. Score 202 will align with a corresponding score or fold line on the carton blank 102. Cut line 203 denotes where the web 114a will be cut by cutting cylinder 111 to separate the web 114a into individual window patches 101.

The notch 201 is die cut with the die cut cylinders 107, 108 and the material within the notch is removed from web 114 in known ways, e.g., by gravity, routing the web through a turn, and/or air jets impinging on the web. The removed material may be collected by a chute 117 which is connected to a removal system (not shown) that conveys waste material away via air flow in a hose or pipe. Notch 201 permits easier folding of carton 102 by reducing shear forces at the fold. The timing or location of notch 201 relative to cut line 203 is adjusted and maintained by control unit 105. An optical scanner 120 provides a timing signal when an edge of notch 201 is detected. The timing signal from scanner 120 is transmitted to control unit 105. In the embodiment in FIG. 1, control unit 105 processes the data and sends signals to servo motor rotating feed cylinders 106 to provide the desired registration between notch 201 and cutline 203. An additional scanner, not shown, may be used to provide a timing signal to control unit 105 in the event that web 104 has printed or other graphic features that must be registered relative to the notches 201.

The score, or perforation, 202 may also be applied by die cutting cylinders 107, 108. Alternatively, the score 202 may be applied at a separate scoring station 118. Scoring station 118 may consist of a scoring wheel or wheels and a separate anvil cylinder, or the scoring wheel, or wheels, may act against die cut anvil cylinder 107, which is not shown in FIG. 1 for simplicity. In this latter embodiment, the scores 202 are not made by the die cylinder 108. This provides an advantage in operation whereby the die cylinder 108 is no longer in 360° contact with web 114. This allows for intentional registration adjustments of die cylinder 108 and relief of inadvertent mismatches of speed of the die cylinder 108 and web 114 between the notches 201. It also allows for the use of heat scoring which is often used, but is not readily compatible on a rotary die cylinder. The score allows a fold to initiate more easily in the rigid window material of web 114.

A scoring station 118 separate from die cutting station 116 also provides another embodiment of the invention, wherein the die cylinder 108 may accommodate repeats other than its circumferential dimension. This is accomplished by rotating die cylinder 108 at a continuous but varying rate, a technique known in the art as profiling or camming. For example, if the die cylinder 108 has a circumference of 10″ and the die pattern for the notches is not in 360° rotational contact with the web 114, the die cylinder may be sped up between the notches to deliver a pattern of notches shorter than the 10″ circumference of the cylinder 108. In this embodiment, and where the die cutting and anvil cylinders 108, 107 are geared together to permit driving with a single servo axis, the web 114 would not be wrapped around the circumference of anvil cylinder 107 and web 114 would be free to slip on anvil cylinder 107 during the rotational increase in speed.

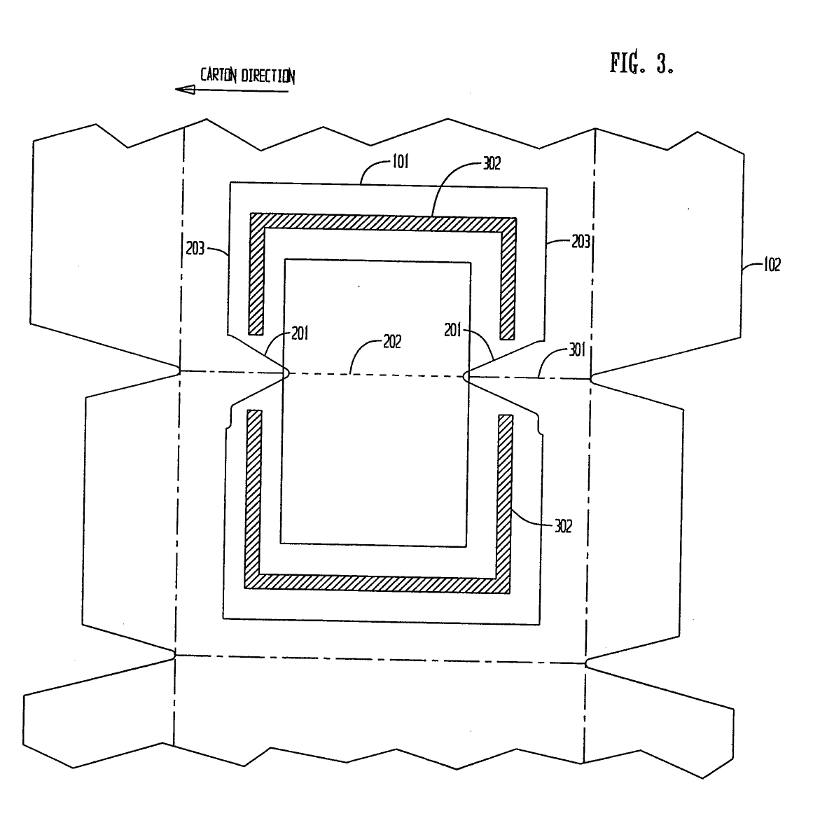

FIG. 3 is a plan view of a window patch 101 attached to a carton 102. The window patch 101 is cut from web 114a by the cutter cylinder 111 at the cut lines 203. The window patch score line 202 aligns with score line 301 of the carton blank 102. The notches 201 serve to reduce shearing forces when carton 102 is folded along score line 301 because the carton remains a single layer at the carton score line 301 as opposed to adding a layer of relatively thick, stiff window material to the thickness of the carton 102. Adhesive pattern 302 is applied by gluing cylinder 109 on the window patch 101 and adheres the window patch 101 onto the carton blank 102. The adhesive is typically a water-based, resin-emulsion, polyvinyl acrylic such as R77115 from Capital Adhesive of Mooresville, Ind. A wide selection of alternative water based adhesives are suitable as well as hot melt adhesives such as rubber-based pressure sensitive adhesives (PSA), polyolefins, or polyurethane reactive (PUR) adhesives which may be substituted in extrusion coating equipment such as ITW Dynatec (of Hendersonville, Tenn.). Apex extruders are used to supplement the water based adhesive.

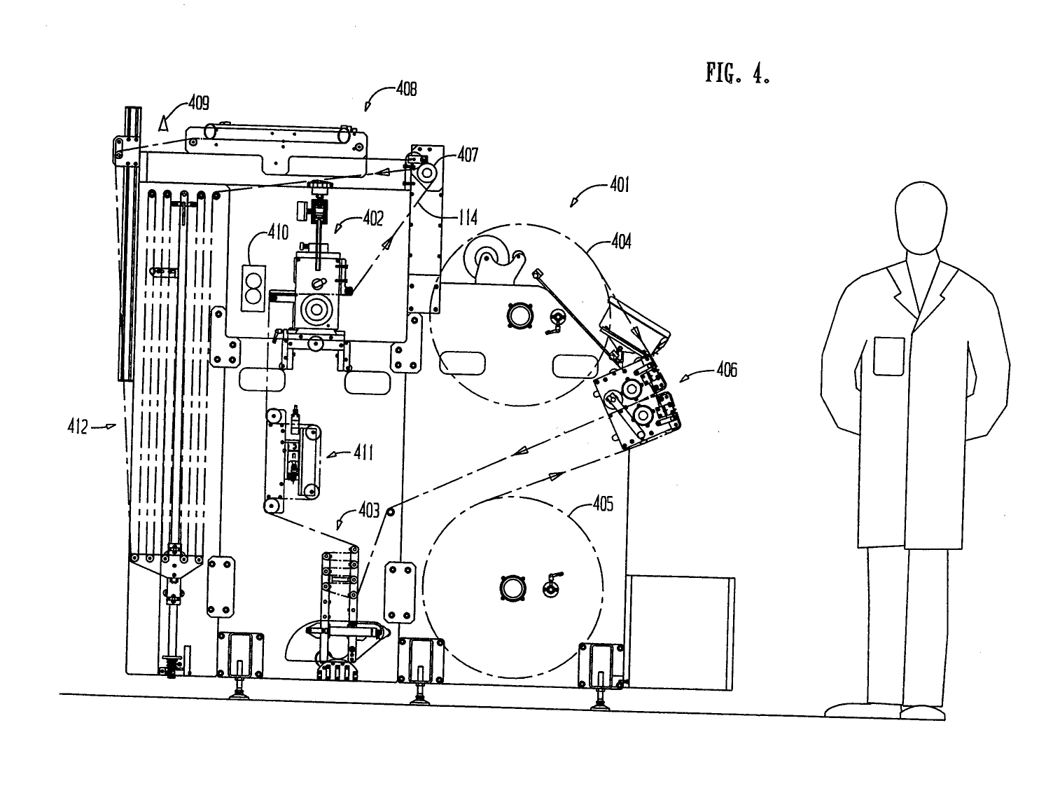

FIG. 4 is a schematic side view of another embodiment of the invention incorporating a splicing system 401 incorporating a rotary die cut station 402 and accumulator 403 suitable for use with a Tamarack Vista® window applicator (as shown to the right of section line A-A in FIG. 1 and previously described herein). Locating the die cut station within the splicer system 410 has the advantage of die cutting the web 114 at a relatively steady, continuous speed compared to the stop-and-go motion of web 114a in the Vista® window applicator (also previously disclosed herein).

The web of window material 114 is supplied from either roll 404 or 405. Splicing head 406 allows a new roll to be spliced to an expiring roll without stopping web 114 (known as a flying splice). Accumulator 403 modulates tension in film web 114 by controlling the spindle brakes for rolls 404 and 405. Accumulator 403 also accommodates brief tension variations that may occur during a splice so the web 114 may be supplied out of accumulator 403 at a relatively constant, continuous speed. Pull roller 407 is servo driven and commanded by control 105 to drive web 114 at a relatively continuous rate that is essentially the average speed of the stop-and-go web 114a in the Vista® window applicator. Accumulator 412 isolates the varying or even stop-and-go consumption of web 114a as it is consumed by the Vista® window applicating machine (see 100 in FIG. 1). The movable, lower carriage in the accumulator 412 moves up as web 114a is demanded and feed roller 407 increases its rotating speed to supply more of web 114 into accumulator to return the lower carriage to a desired position or set point. The large web storage capacity of large accumulator 412 allows replenishing of web 114 into accumulator 412 by feed roll 407 at a relatively steady rate, with low accelerations and decelerations while web 114a may be withdrawn from the accumulator at varying rates, even relatively high accelerations and decelerations of, for example, 90 ft/sec² at frequencies of approximately 600 cycles/minute.

Splicing system 401 may be used in various positions relative to the Vista® applicator, for example, on the front or rear side of the Vista®, and parallel or perpendicular to the Vista®. One or more turn bars, such as the turn bar assembly 408, may be located between the Vista® and the splicing system 401 to maneuver the web 114 through the required 90° turns as is known in the art. The drag of the turn bars may serve to undesirably add tension to the web, however control system 105 may be used to advantageously adjust the speeds of feed rollers 106 and 407 so that tension remains desirably low and nearly constant through any such turn bars. This reduces scratching of the window material and reduces variation in lateral tracking of the web 114.

A scanner 409 is used to detect the position of the die cut notches 201 and the scanner output is transmitted to control system 105 and processed to command adjustments for feed cylinder 106 rotation in relation to the cutter cylinder 111 to register the position of the notch 201 relative to the position of the cut line 203.

As described previously herein, it may be advantageous to separate the diecutting and scoring operations by adding a scoring station 410.

A conventional web guide 411 is provided to control the lateral position of the web as it enters the scoring and slitting station.

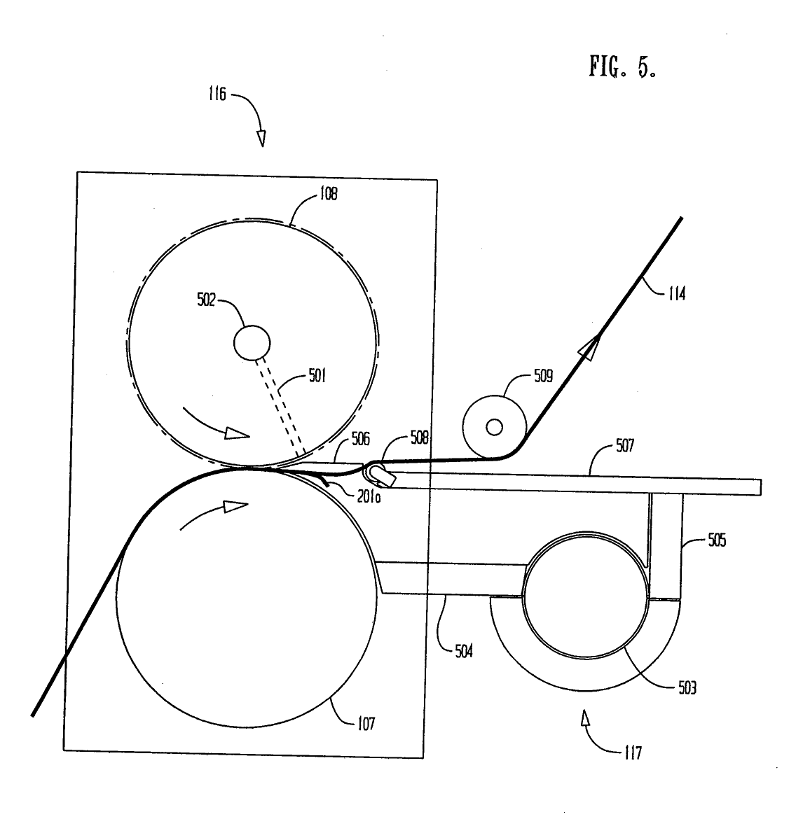

FIG. 5 is a schematic side view detailing the features of a notch waste removal and collection chute 117.

Web 114 is routed through the die cut station 116 where die cylinder 108 has a raised cutting edge shaped to define notch 201 of FIG. 2 when web 114 is pinched between the cutting edge on die cylinder 108 and anvil cylinder 107, using known die cutting techniques. The chute assembly 117 assists in the removal and collection of notch waste 201a. Notch waste 201a is within the perimeter of notch 201 of FIG. 2. As seen in FIG. 5, an air jet 501 is provided in die cutting cylinder 108 and fed with a compressed air source via central drilling 502. An air jet may be provided in other known ways such as a small pipe directed to a similar area. The integral air jet 501 has the advantage of acting on the notch waste 201a as soon as it is die cut, to help direct it into the chute 117. Chute 117 is equipped with a vacuum supply 503 via known methods such as a flexible hose attached to collection chamber and blower such as a wood worker's dust collection unit supplied by Jet of Taiwan, with U.S. offices in LaVergne, Tenn. The vacuum force acting on notch waste 201a is combined with the air jet from drilling 501 help dislodge the notch waste 201a from web 114. Once free of web 114, notch waste 201a is collected in the notch collection chute 117 and conveyed to a collection system (not shown). The notch collection chute 117 is equipped with a bottom plate 504, a back plate 505, side baffles 506 and a top plate 507 to define the chute 117. A portion of web 114 defines the remaining portion of chute 117, effectively (but not perfectly) sealing the chute to assure a vacuum therein which adds to the force of the air jet 501 and assists in removal of the notch waste 201a. Top plate 507 is equipped with a roller 508, or the like, to reduce the frictional force acting on web 114 as it is pulled against the roller by vacuum from within the notch collection chute 117. Top plate 507 may be adjusted to the left or right (in the orientation shown in FIG. 5) to accommodate the unsupported span of web 114. The adjustment allows for accommodation of different vacuum levels and web stiffnesses. Idler 509 is located advantageously to insure that web 114 is routed as desired including into contact with roller 508.

While particular embodiments of the present invention have been shown and described, it will be obvious to those skilled in the relevant arts that changes and modifications may be made without departing from the invention in its broader aspects. Therefore, the aim in the appended claims is to cover all such changes and modifications that fall within the true spirit and scope of the invention. The matter set forth in the foregoing description and accompanying drawings is offered by way of illustration only and not as a limitation. The actual scope of the invention is intended to be defined in the following claims when viewed in their proper perspective based on the prior art.

1. A method for affixing rigid windows of transparent material in a continuous manner to plural folding cartons each having at least one first score line thereon, the method comprising the steps of:
providing a moving web of rigid window material in a continuous manner;
forming a second score line in the moving web of rigid window material;
cutting spaced notches along said second score line in the moving web of rigid window material;
removing and collecting notch waste produced in the cutting of spaced notches in the moving web of rigid window material;
changing the continuous motion of the moving web to stop-and-go motion;
applying an adhesive in a spaced manner to the stop-and-go moving web of rigid window material adjacent the second score line therein;
cutting said stop-and-go moving web so as to form plural individual window patches, wherein each window patch has adhesive thereon and includes a second score line and at least one notch therein;
providing plural folding cartons in a spaced manner; and
applying one or more of said window patches to each of said folding cartons, wherein the adhesive on each of said one or more window patches is in contact with an associated folding carton and said second score line on said one or more window patches is aligned with a first score line on said associated folding carton.

2. The method of claim 1, wherein said second score line and said spaced notches are formed in a continuous, non-stop manner.

3. The method of claim 1, wherein the step of forming said second score line and cutting spaced notches along said second score line includes passing the moving web between and in contact with a rotary cutting die and a rotary anvil feeding cylinder.

4. The method of claim 3, wherein said rotary anvil feed cylinder is in continuous contact with the moving web, and wherein said rotary cutting die is in continuous contact with said moving web during forming of said score line and is in intermittent contact with said moving web during cutting of said spaced notches.

5. The method of claim 3, wherein the forming of said second score line and the cutting of spaced notches in said moving web is performed simultaneously at a single station.

6. The method of claim 2, wherein in the step of collecting and removing notch waste includes forming a vacuum and exposing a first surface of said moving web to the vacuum.

7. The method of claim 5, wherein the vacuum is contained at least partially by said moving web.

8. The method of claim 5, wherein the step of collecting and removing notch waste further includes directing a jet of air under pressure onto a second opposed surface of said moving web where the vacuum is applied.

9. The method of claim 8, wherein the step of directing a jet of air under pressure onto the second opposed surface of said moving web includes directing air under pressure through a die cutting cylinder used to form a notch in the moving web.

10. The method of claim 9 further comprising the step of directing the notch waste to a removal and collection chute leading away from the moving web.

11. The method of claim 9, wherein the air under pressure is directed onto the cut out notch waste as the cutout notch waste is formed.

12. The method of claim 1, wherein the step of applying one or more of said window patches to a folding carton provides an immediate visual indication of the alignment of the respective first and second scores of each folding carton and its associated window patch to permit score alignment correction, if necessary.

13. The method of claim 1, wherein the step of applying a window patch to a folding carton includes self-alignment of a second score line of said window patch with a first score line of an associated folding carton during setting of said adhesive.

14. The method of claim 13 further comprising the step of providing a transition motion to the web between its continuous motion and its stop-and-go motion for reducing cyclic peaks of tension associated with the stop-and-go motion of the web.

15. The method of claim 1, wherein the steps of forming a second score line and cutting spaced notches, and collecting and removing notch waste are performed with the web continuously moving, while the steps of applying adhesive and cutting the moving web so as to form plural individual window patches are performed with the web in stop-and-go motion.

16. The method of claim 15, wherein the step of providing a transition motion to the web includes temporarily storing the web in a festooned manner which facilitates removal of the temporarily stored web in a stop-and-go manner.

17. The method of claim 1 further comprising the step of scanning a die cut feature in the moving web following the cutting of spaced notches therein for use in providing registration between each notch and subsequent cutting of the moving web in forming an individual window patch.

18. The method of claim 1, wherein the second score line is first formed in the moving web by a scoring station followed by cutting of a notch in the moving web by a cutting station.

19. The method of claim 18, wherein the step of forming said second score line includes engaging the moving web with a rotary die scoring cylinder and the step of cutting a notch includes engaging the moving web with a rotary die cutting cylinder.

20. The method of claim 1, wherein the step of providing a moving web of rigid material includes providing a first moving web from a first roll, followed by providing a second moving web from a second roll following depletion of said first roll by splicing said first and second moving webs.

21. The method of claim 1 further comprising the step of subjecting the moving web to one or more 90° turns in proceeding from the steps of forming a second score line and cutting spaced notches in the continuously moving web to the steps of applying adhesive to and cutting the stop-and-go moving web to reduce tension in the moving web in transitioning from continuous to stop-and-go web movement.

22. The method of claim 1 further comprising the steps of monitoring the relative positions of said notches and cut lines used in cutting said moving web to form said individual window patches, and adjusting the speed of the moving web and/or the rate at which the moving web is cut to provide window patches of a desired size.

23. The method of claim 1, wherein the width of said window patches and the width of said moving web are equal.

24. Apparatus for forming and applying a rigid window of transparent material on a series of plural folding moving cartons each having a first score line thereon, said apparatus comprising:
a first conveyance arrangement for removing and displacing a first web of rigid transparent material from a first roller in a continuous manner;
a scoring station for receiving from said first roller the rigid transparent material web and forming a second score therein;
a notching station for receiving the scored transparent material web and forming plural spaced notches along said second score in the transparent material web;
a first accumulator for continuously receiving the scored and notched transparent material web and storing said transparent material web in an easily removable manner;
a second conveyance arrangement for removing the transparent material web from said accumulator and moving the transparent material web in a stop-and-go manner;
a first applicator for applying an adhesive to the stop-and-go transparent material web in a spaced manner;
a cutting mechanism for receiving and cutting the stop-and-go transparent material web into plural spaced transparent material patches, wherein each of said transparent material patches has applied adhesive thereon; and
a second applicator for receiving and sequentially applying each transparent material patch to a respective one of said plural moving folding cartons.

25. The apparatus of claim 24, wherein said scoring and notching stations are combined so as to form said second score and said spaced notches in the rigid transparent material web simultaneously.

26. The apparatus of claim 24 further comprising a vacuum chamber located adjacent a first surface of the transparent material web where said plural spaced notches are formed therein for removing and disposing of severed portions of the notched transparent material web.

27. The apparatus of claim 26 further comprising a pressurized air source located adjacent said vacuum chamber for directed a jet of air on a second opposed surface of the transparent material web for facilitating separation and removal of the severed portions of the transparent material web.

28. The apparatus of claim 24 further comprising a third conveyance arrangement for removing and displacing a second web of rigid transparent material from a second roller and a splicer arrangement for attaching a leading end of said second web to a trailing end of said first web upon depletion of said first web for providing the first and second webs in a continuous manner.

29. The apparatus of claim 28 further comprising a second accumulator for continuously receiving said first web and then said second spliced web and temporarily storing said first and second webs in an easily removable manner for delivery to said scoring and notching stations.

30. The apparatus of claim 26 further comprising a collection chute coupled to said vacuum chamber for receiving and directing notch waste formed by said notching station away from the moving transparent material web.

31. The apparatus of claim 24 further comprising a scanner for scanning the moving transparent material web for a die cut feature for use in providing registration between each notch and subsequent associated cutting of the moving transparent material web in forming an individual window patch.

32. The apparatus of claim 24 further comprising a controller for monitoring the relative positions of said notches and cut lines used in cutting said moving transparent material web to form said individual window patches, and adjusting the speed of the moving transparent material web and/or the rate at which the moving transparent material web is cut to provide window patches of a desired size.
